(19) United States
(12) Patent Application Publication
(10) Pub. No.: US 2006/0072075 A1
(43) Pub. Date: Apr. 6, 2006

(54) Projection system with contrast homogeneity correction

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,613

(22) PCT Filed: Nov. 5, 2003
(86) PCT No.: PCT/IB03/05117

§ 371 Date: Jun. 10, 2005

(30) Foreign Application Priority Data
Dec. 11, 2002 (EP) 02080249.2

(51) Int. Cl. G03B 21/26

(52) U.S. Cl. 353/30

(57) ABSTRACT

The invention relates to a projection system (10) for projecting an image onto a screen (16). The system (10) comprises a main video projector (14) arranged to project a main image onto the screen (16), and further a contrast correction projector (12) arranged to project a correction image onto the screen (16) to compensate for imperfections in the image projected by the main video projector (14). The correction projector (12) may be a cheap and simple projector using for its light source light emitting diodes or stray light from the main projector. Typically, the correction projector (12) gives a steady image on the screen (16), only compensating for the imperfections in the main image displayed by the main projector.

### FIELD OF THE INVENTION

The present invention relates to improvements of image quality in projection display systems. In particular, the invention relates to correction of contrast homogeneity for rear projection systems.

### BACKGROUND OF THE INVENTION

In lightvalve-based projection systems, the black level (the contrast) of the projected image is generally not homogeneous. Reasons for this lack of homogeneity in the black level of the image are that light leaks to undesired portions of the projection screen or that too little light reaches some portions of the screen.

It is difficult and expensive to manufacture a projector generating an entirely homogeneous image. Therefore, the contrast (or color) homogeneity for a projector-based display system needs to be corrected during factory testing. To accomplish this correction, the image color is typically measured on a large number of locations in the image, and corrected electronically in the projector where variations are found. If this measuring process and electronic correction could be avoided, display systems having a high contrast homogeneity could be manufactured at lower costs than present systems.

Consequently, there is a need for new display systems of the projection type where this problem of contrast homogeneity is addressed.

### OBJECT AND SUMMARY OF THE INVENTION

Therefore, it is an object of the present invention to provide a projection system for which the degree of homogeneity in the black level is considerably improved.

This object is achieved by means of a projection system as defined in claim 1.

Thus, the projection system according to the invention comprises a main video projector arranged to project a main image onto the screen, and a contrast correction projector arranged to project a contrast correction image onto the screen to compensate for contrast inhomogeneities in the image projected by the main video projector.

The dependent claims define preferred embodiments of the inventive projection system.

Video projectors usually have imperfections resulting in a non-homogeneous contrast in the displayed image. For example, this may be perceived as dark corners in the image or the like. As mentioned above, the contrast homogeneity issues have been addressed in the prior art by introducing electronic correction in the projection engine itself. However, correction of the black level (contrast) homogeneity in a projector by means of additional electronics leads to increased cost and production time. In addition, such a solution to the homogeneity problem reduces the bit-depth of the display, and thus the number of available shades of gray.

It has now been found that the black level can be made homogeneous by employing a second projector, called a contrast correction projector, which delivers just the amount of light necessary to balance the black level (contrast) of the projected image on a screen.

The invention is based on the recognition that only very little light is required in order to balance the black level. Therefore, the contrast correction projector may be a very simple and cheap one. The light source in the contrast correction projector may be light emitting diodes, or even stray light from the main projector. Furthermore, the contrast correction projector need not be arranged to project a moving image as the main projector, but only a stable image to correct imperfections in the main projector. Hence, the projection system according to the present invention can be manufactured at low cost.

Features and aspects of the invention will be appreciated from the description of a preferred embodiment thereof set out below.

### BRIEF DESCRIPTION OF THE DRAWINGS

The invention will be described in more detail with reference to the accompanying drawing, in which:

FIG. 1 shows a diagram of the projection system according to the invention.

### DETAILED DESCRIPTION OF A PREFERRED EMBODIMENT

In the specification below, as well as in the drawing, reference is made to a back-projection system. However, it will be obvious to the skilled person that the principles of the invention can also be applied to front projection systems, where the viewer and the projector are positioned on the same side of the screen. In back-projection systems, a folding mirror is normally used to fold the light path from the projector to the screen. For reasons of clarity, such a folding mirror has been omitted in the Figure. The arrangements of folding mirrors is common practice in the art, and the skilled person will know various ways of implementing the present invention in this respect.

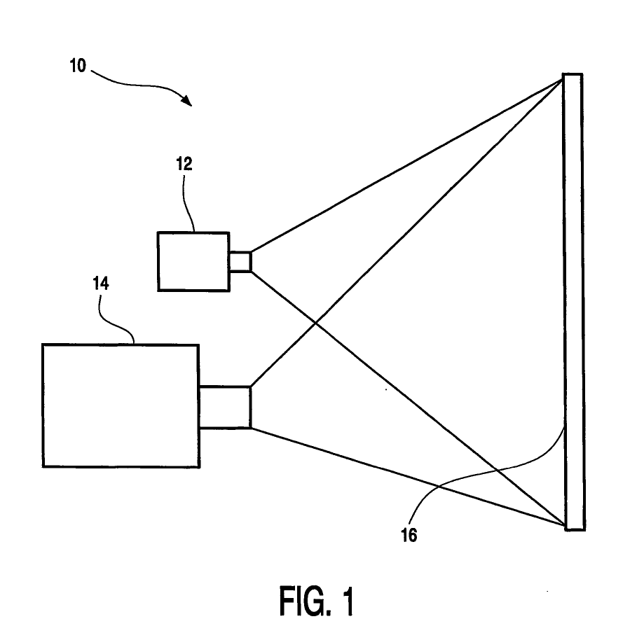

FIG. 1 shows schematically a projection display system 10 according to the invention. The system includes a main projection engine 14 which is arranged to project a main video image onto a screen 16. The main projection engine (the main video projector) 14 is of a suitable known type, and has a video/data input for receiving a video/data signal to be displayed on the screen 16.

In order to compensate for imperfections in the main projection engine 14, resulting in non-homogeneous contrast (black level) in the displayed image on the screen 16, a second projector 12 called a contrast correction projector is included in the inventive projection system 10. The contrast correction projector 12 is arranged to project an image onto the screen having just enough brightness to compensate for the contrast, or black level, imperfections in the main projector 14. This also means that no contrast homogeneity correction is necessary in the main video projector itself.

For a rear projection system, both the main projector 14 and the correction projector 12 are arranged within the rear projection cabinet. Due to the typically small size of the correction projector 12, the overall size of the projection system remains substantially unaffected.

As an example, the main video projector 14 may have a brightness of 500 lumen (although any type of projector can be used in connection with the present invention) and a contrast ratio of 500:1, resulting in a black level of 1 lumen. This lack of homogeneity in the contrast of the displayed image is compensated for by projecting a second image onto the screen 16 from the contrast correction projector 12. It is to be understood that the contrast correction projector needs a brightness of only 1 lumen to accomplish this task.

In general, the required corrections will be at the level of some few lumen (1 lumen in the example above), so that the brightness requirements on the contrast correction projector are very low. This means that the light source for the correction projector 12 may be a simple and cheap one. The light source may be, for example, light emitting diodes in the correction projector 12. In fact, sufficient brightness can be obtained for the correction projector even by using stray light from the main video projector 14.

The image projected onto the screen by the main video projector 14 generally exhibits areas of lower brightness and areas of higher brightness due to imperfections in the main projector 14. This brightness variation across the image leads to a poor homogeneity for the contrast in the image. To increase the perceived image quality, the contrast correction projector 12 is arranged to project an image onto the screen 16 having a brightness variation that is opposite to that of the main projector 14. This means that the correction projector 12 during operation projects an image onto the screen having a brightness that is higher at the portions where the brightness of the main image is low, and vice versa. Consequently, the contrast homogeneity of the displayed image is corrected (balanced) in a simple and reliable manner.

Typically, the contrast correction projector 12 will have a brightness that is less than 10 percent of the main projector brightness. Often, the brightness of the correction projector 12 may be about 1 percent, or less, of the main projector brightness. It will be clear from this fact that the requirements of the light source for the correction projector 12 are low, so that light emitting diodes or stray light from the main projector 14 can be utilized.

It is to be noted that the image displayed by the correction projector 12 may be a stable image (and not a moving image), compensating just for the spatial variations in main brightness. The imperfections of the main video projector can be determined during factory testing, and the properties of the correction projector 12 are adjusted accordingly. However, in some cases it may be preferred to have the correction projector 12 projecting a moving image.

Moreover, it is obvious that the display system according to the present invention is equally suitable for video images and for computer graphics.

The present invention has particular applicability in LCOS (Liquid Crystal On Silicon) projection systems. Nevertheless, the invention can also be used in other types of projection systems where the contrast of a displayed image needs to be corrected.

In conclusion, a projection system for projecting an image onto a screen has been disclosed. The system comprises a main video projector arranged to project a main image onto the screen, and further a contrast correction projector arranged to project a correction image onto the screen to compensate for imperfections in the image projected by the main video projector. The correction projector may be a cheap and simple projector using for its light source light emitting diodes or stray light from the main projector. Typically, the correction projector gives a steady image on the screen, only compensating for the imperfections in the main image displayed by the main projector.

1. A projection system (10) for projecting an image onto a screen (16), the system comprising a main video projector (14) arranged to project a main image onto the screen (16), characterized in that the system (10) further comprises a contrast correction projector (12) arranged to project a contrast correction image onto the screen (16) to compensate for contrast inhomogeneities in the image projected by the main video projector (14).

2. A projection system as claimed in claim 1, wherein the contrast correction projector (12) has a brightness output that is less than 10 percent of the brightness output of the main projector (14).

3. A projection system as claimed in claim 1, wherein the contrast correction projector (12) is arranged to project a stable image onto the screen (16).

4. A projection system as claimed in claim 1, wherein the contrast correction projector (12) is arranged to use stray light from the main projector (14) as its light source.

5. A projection system as claimed in claim 1, wherein the contrast correction projector (12) comprises light emitting diodes as its light source.

6. A projection system as claimed in claim 1, wherein the system (10) is a rear projection system.
